(19) United States
(12) Patent Application Publication
(10) Pub. No.: US 2013/0076262 A1
(43) Pub. Date: Mar. 28, 2013

(54) Lighting Device, Lighting Equipment, and Lighting Control System

(71) Applicants: Yoko Noguchi, Yokosuka-Shi (JP); Kazunori Yashiro, Yokosuka-Shi (JP); Tomoko Ishiwata, Yokosuka-Shi (JP); Kenji Takahashi, Yokosuka-Shi (JP); Fumie Iwata, Yokosuka-Shi (JP); Shigehisa Kawatsuru, Yokosuka-Shi (JP); Hitoshi Kawano, Yokosuka-Shi (JP)

(72) Inventors: Yoko Noguchi, Yokosuka-Shi (JP); Kazunori Yashiro, Yokosuka-Shi (JP); Tomoko Ishiwata, Yokosuka-Shi (JP); Kenji Takahashi, Yokosuka-Shi (JP); Fumie Iwata, Yokosuka-Shi (JP); Shigehisa Kawatsuru, Yokosuka-Shi (JP); Hitoshi Kawano, Yokosuka-Shi (JP)

(73) Assignee: TOSHIBA LIGHTING & TECHNOLOGY CORPORATION, Yokosuka-shi (JP)

(21) Appl. No.: 13/565,601

(22) Filed: Aug. 2, 2012

(30) Foreign Application Priority Data
Sep. 26, 2011 (JP) 2011-209067
Sep. 26, 2011 (JP) 2011-209068
Jan. 12, 2012 (JP) 2012-003976

(51) Int. Cl. H05B 37/02

(52) U.S. Cl. 315/297; 315/294

(57) ABSTRACT

According to an embodiment, a lighting device includes a first to fourth light sources, a control unit, and an operation unit. The first to fourth light sources have a different combination of a relatively high/low correlated color temperature and a relatively high/low general color rendering index from each other. The control unit controls at least two of a light flux, the correlated color temperature, and the general color rendering index of each of the light sources. The operation unit designates at least one of the correlated color temperature and the general color rendering index of each of the light sources, and executes spectral distribution with the designated correlated color temperature, or general color rendering index.

### CROSS-REFERENCE TO RELATED APPLICATIONS

This application is based upon and claims the benefit of priority from Japanese Patent Application Nos. 2011-209067 filed Sep. 26, 2011, 2011-209068 filed Sep. 26, 2011 and 2012-003976 filed Jan. 12, 2012; the entire contents all of which are incorporated herein by reference.

### FIELD

Embodiments described herein generally relate to a lighting device, a lighting equipment, and a lighting control system which are able to make various lighting environments.

### BACKGROUND

In order to create various lighting environments, in general, the light color and the brightness are adjusted by providing a plurality of light sources which are different light colors from each other, or which are dimmable, such as white light of a fluorescent lamp, or warm light of a light bulb.

However, in order to create the various lighting environments, it is necessary to make a color appearance (color rendering property) good, for example, so that the color of clothes selected in a shop does not look different from the color in mind when walking outside wearing the clothes. For this reason, how to control the color appearance, and to create the various lighting environments become important, in addition to controlling of the light color and the brightness.

In addition, as described above, at a shop or the like, a correlated color temperature, or a general color rendering index Ra of a lighting equipment is an important element when considering the atmosphere of a space, or the appearance of good. In particular, the higher the general color rendering index Ra, the better the color appearance; however, on the other hand, the high general color rendering index has a trade-off relationship with the efficiency of the equipment. Accordingly, there is a problem that it is difficult for a user to determine the degree of the general color rendering index Ra when buying the equipment.

### BRIEF DESCRIPTION OF THE DRAWINGS

FIG. 1A is a front view of light emitting modules of a lighting device according to a first embodiment.

FIG. 1B is a rear view of the light emitting modules of the device.

FIG. 2 is an enlarged cross-sectional view of a light source of the device.

FIG. 3 is a diagram of a spectral distribution of each light source of the device.

FIG. 4 is a front view which shows a part of the light emitting modules of the device, which is enlarged.

FIG. 5 is an electrical circuit diagram of the device.

FIG. 6 is a graph which shows a dimming rate of each light source when a luminous flux of an equipment in the lighting device is constant, a correlated color temperature is 3500 K, and a general color rendering index Ra is in a range of 70 to 95.

FIG. 7 is a graph which shows the dimming rate of each light source when the luminous flux of the equipment in the lighting device is constant, the general color rendering index Ra is 80, and the correlated color temperature is in a range of 2850 K to 5000 K.

FIG. 8 is a front view which shows an operation unit of the device.

FIG. 9A is a perspective view which shows a lighting equipment by cutting out a part thereof.

FIG. 9B is a front view of a base body of the equipment.

FIG. 10 is a view which shows a lighting control system of the device, and a ceiling at which the lighting equipment is provided.

FIG. 11 is a front view which shows light emitting modules of the device in a modification example by enlarging a part thereof.

FIGS. 12A to 12D are graphs which describe a second embodiment.

### DETAILED DESCRIPTION

Hereinafter, exemplary embodiments will be described in detail with reference to drawings.

A lighting device according to the embodiments includes, a first light source, a correlated color temperature of which is relatively high, and a general color rendering index of which is relatively high; a second light source, a correlated color temperature of which is relatively high, and a general color rendering index of which is relatively low; a third light source, a correlated color temperature of which is relatively low, and a general color rendering index of which is relatively high; a fourth light source, a correlated color temperature of which is relatively low, and a general color rendering index of which is relatively low; and a control unit which controls at least two of a light flux, the correlated color temperature, and the general color rendering index of each of the light sources.

In addition, in the lighting device according to the embodiments, the first light source is a first light emitting diode which includes a blue light emitting diode, and a phosphor which is excited by the blue light emitting diode, whose correlated color temperature is 5000 K, or more, and whose general color rendering index is 90, or more; the second light source is a second light emitting diode which includes a blue light emitting diode, and a phosphor which is excited by the blue light emitting diode, whose correlated color temperature is 5000 K, or more, and whose general color rendering index is 70 or less; the third light source is a third light emitting diode which includes a blue light emitting diode, and a phosphor which is excited by the blue light emitting diode, whose correlated color temperature is 3000 K, or less, and whose general color rendering index is 90, or more; and the fourth light source is a fourth light emitting diode which includes a blue light emitting diode, and a phosphor which is excited by the blue light emitting diode, whose correlated color temperature is 3000 K, or less, and whose general color rendering index is 70, or less.

In addition, when the control unit of the lighting device according to the embodiments changes a correlated color temperature with a gradation of 50 to 100 K based on a certain condition of the general color rendering index, a change in color in JIS color rendering color chart No. 1 to No. 8 becomes a color difference ΔE*ab of 0.9 or less.

In addition, the lighting device according to the embodiments includes an operation unit which designates at least one of the correlated color temperature and the general color rendering index of each of the light sources, and executes spectral distribution with the designated correlated color temperature and general color rendering index.

In addition, a lighting equipment according to the embodiments includes an equipment main body, and a lighting device which is disclosed in any one of claims 1 to 4, and is arranged in the equipment main body.

In addition, a lighting control system according to the embodiments includes the above-described lighting device.

In addition, the lighting control system according to the embodiments includes an equipment main body and the above lighting device arranged in the equipment main body.

### First Embodiment

A first embodiment is configured by a lighting control system, for example, which is provided at an illumination showroom at which various illumination environments can be created, and the various illumination environments can be experienced, a lighting device and a lighting equipment which are used in the lighting control system. Here, a configuration of the lighting device will be described.

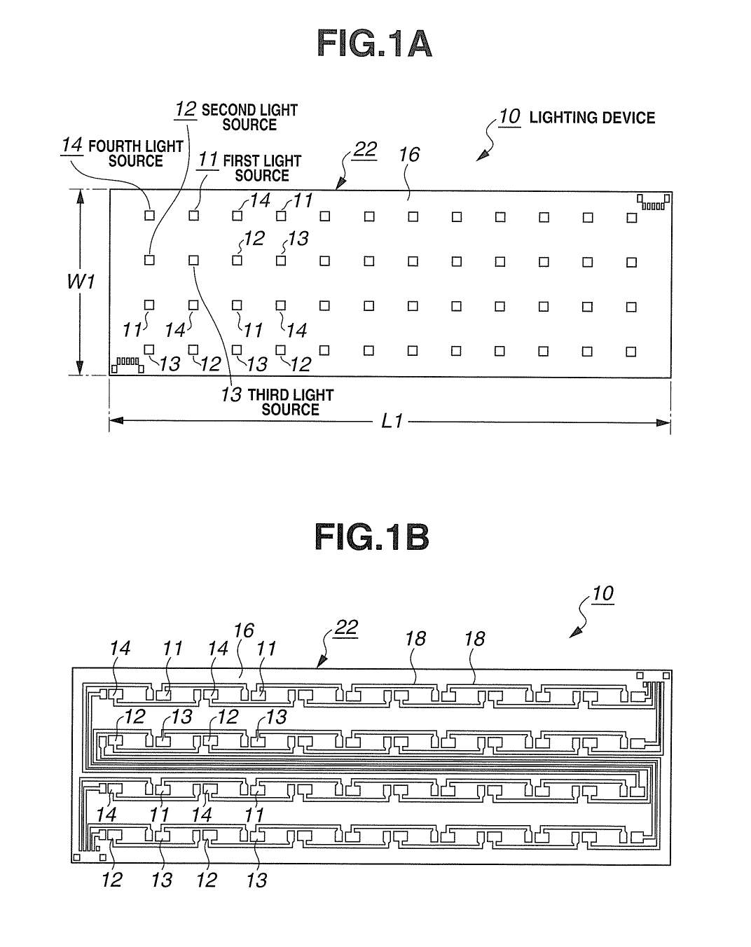

A lighting device 10 according to the embodiment is a lighting device in which a light emitting diode (hereinafter, referred to as “LED”) is a light source, and as shown in FIGS. 1A and 1B, the device is configured by a first light source 11, a correlated color temperature of which is relatively high, and a general color rendering index Ra of which is relatively high; a second light source 12, a correlated color temperature of which is relatively high, and a general color rendering index Ra of which is relatively low; a third light source 13, a correlated color temperature of which is relatively low, and a general color rendering index Ra of which is relatively high; a fourth light source 14, a correlated color temperature of which is relatively low, and a general color rendering index Ra of which is relatively low; and a control unit 30 which controls a light flux, the correlated color temperature, and the general color rendering index Ra of each of the light sources; and an operation unit 35 which designates at least one of the correlated color temperature and the general color rendering index Ra of each of the light sources and executes the spectral distribution with the designated correlated color temperature and general color rendering index RA.

According to the embodiment, the above-described first to fourth light sources 11 to 14 are configured as follows.

The first light source 11 is configured by a first LED which includes a blue light emitting diode, and a phosphor which is excited by the blue light emitting diode, whose correlated color temperature is 5000 K, or more, approximately 5000 K according to the embodiment, and whose general color rendering index Ra is 90, or more, and approximately 92 according to the embodiment.

The second light source 12 is configured by a second LED which includes the blue light emitting diode, and the phosphor which is excited by the blue light emitting diode, whose correlated color temperature is 5000 K, or more, approximately 5000 K according to the embodiment, and whose general color rendering index Ra is 70, or less, and approximately 70 according to the embodiment.

The third light source 13 is configured by a third LED which includes the blue light emitting diode, and the phosphor which is excited by the blue light emitting diode, whose correlated color temperature is 3000 K, or less, approximately 2700 K according to the embodiment, and whose general color rendering index Ra is 90, or more, and approximately 92 according to the embodiment.

The fourth light source 14 is configured by a fourth LED which includes the blue light emitting diode, and the phosphor which is excited by the blue light emitting diode, whose correlated color temperature is 3000 K, or less, approximately 2700 K according to the embodiment, and whose general color rendering index Ra is 70, or less, and approximately 67 according to the embodiment.

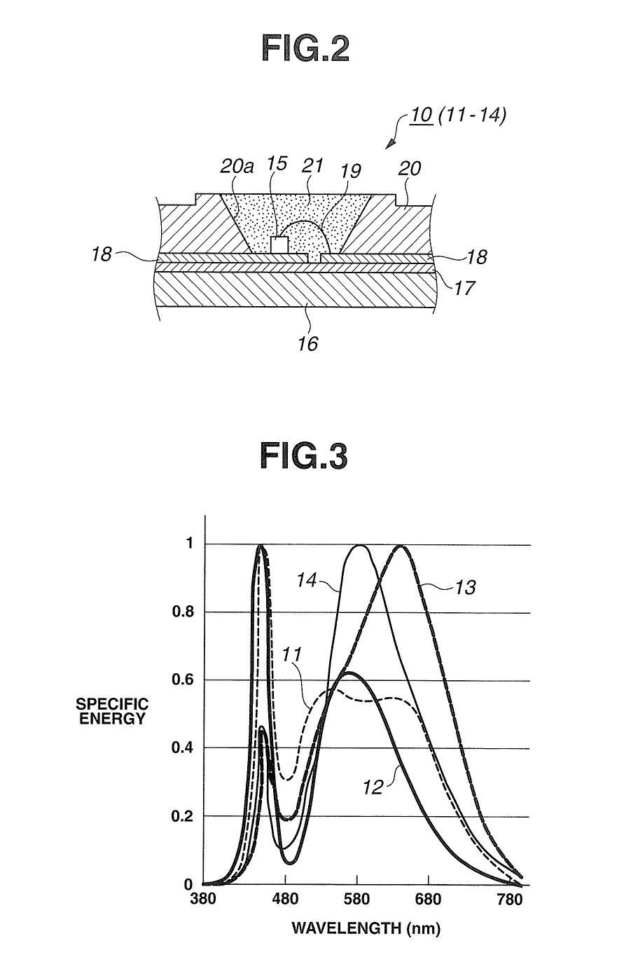

In addition, the above-described first to fourth light sources 11 to 14 are configured by LEDs of an SMD (surface mount device) type, and as shown in FIG. 2, a blue LED chip 15 is mounted on a substrate 16 having a circuit pattern. In addition, the LED may be a COB (chip on board) type which is configured by including a plurality of LED chips which are directly mounted on the substrate and a phosphor which is excited by light which is radiated from the LED chips, and being sealed with resin.

A rectangular flat plate which is formed of aluminum or the like with a heat radiation property and rigidity is used for the substrate 16, and respective circuit patterns 18 on the cathode side and the anode side are formed through an electrically insulating layer 17. The circuit pattern 18 is formed of copper (Cu) or the like.

In addition, a base electrode of the blue LED chip 15 is electrically connected to the circuit pattern 18 on one electrode side, and a top face electrode is electrically connected to the circuit pattern 18 on the other electrode side through a bonding wire 19 which is formed of a gold wire or the like. In addition, a resin frame 20 is provided on the substrate 16, and a concave portion 20a is formed in the frame. The frame 20 is formed of synthetic resin such as white PBT (polybutylene terephthalate) or the like, and the blue LED chip 15 is arranged and accommodated at the center portion in the concave portion 20a.

In addition, a phosphor resin layer 21 in which phosphor resin, in which a phosphor is mixed with transparent resin such as silicone resin, or epoxy resin, and distributed, is coated or filled is formed in the concave portion 20a in which the blue LED chip 15 is accommodated. The blue LED chip 15 is configured by being covered with the phosphor resin layer 21. In addition, blue light which is radiated from the blue LED chip 15, and light which is radiated from the phosphor which is excited by the blue LED chip 15 are mixed with each other, thereby radiating white light.

The above-described first to fourth light sources 11 to 14 respectively have the same configurations as that in FIG. 2 which is described above; however, the phosphors included in the phosphor resin layers 21 are different from each other. That is, it is configured such that light with necessary correlated color temperature and general color rendering index Ra is obtained by selecting the phosphors with the desired performances.

That is, as shown by a curve 11 (thin dotted line) in a graph in FIG. 3, the first light source 11 emits bluish light whose peak wavelength is in a range of approximately 440 nm, and whose correlated color temperature is 5000 K or more, approximately 5000 K in the embodiment, the general color rendering index Ra is 90 or more, and approximately 92 in the embodiment.

As shown by a curve 12 (thick solid line) in the graph in FIG. 3, the second light source 12 emits bluish light whose peak wavelength is in a range of approximately 440 nm, the correlated color temperature is 5000 K or more, approximately 5000 K in the embodiment, and whose general color rendering index Ra is 70 or less, and approximately 70 in the embodiment.

As shown by a curve 13 (thick dotted line) in the graph in FIG. 3, the third light source 13 emits reddish light whose peak wavelength is in a range of approximately 640 nm, the correlated color temperature is 3000 K or less, approximately 2700 K in the embodiment, and whose general color rendering index Ra is 90 or more, and approximately 92 in the embodiment.

As shown by a curve 14 (thin solid line) in the graph in FIG. 3, the fourth light source 14 emits yellowish light whose peak wavelength is in a range of approximately 580 nm, the correlated color temperature is 3000 K or less, approximately 2700 K in the embodiment, and whose general color rendering index Ra is 70 or less, and approximately 67 in the embodiment.

As shown in FIGS. 1A and 1B, in each of the first to fourth light sources 11 to 14 which is configured as described above, each of the first to fourth LEDs is arranged with respect to the rectangular substrate 16. For each of the light sources (each one of the first to fourth LEDs, that is, four LEDs are one set), 12 sets are used by being connected in series. In addition, each of the first to fourth LEDs has a predetermined interval which is approximately equal to each other, and is arranged so as to form a row approximately in parallel along the longitudinal direction of the substrate 16, thereby forming a rectangular light emitting module 22. The light emitting module 22 according to the embodiment which is configured as above has a length L1 of approximately 256 mm, and a width W1 of approximately 84 mm.

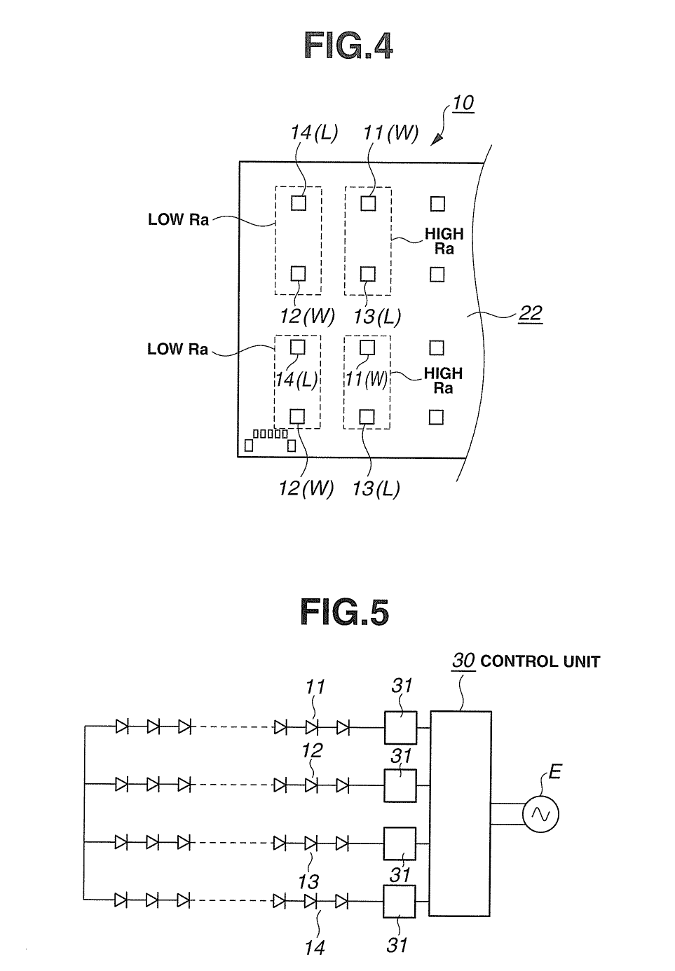

In addition, according to the embodiment, each of the light sources 11 to 14 is arranged as follows. That is, as shown in FIG. 4 by enlarging a part thereof, when the rectangular light emitting module 22 is seen in a unit of eight chips in the vertical direction of the figure, as shown in a group of frame of dotted lines in the figure, each of four “low Ra” LED chips in the vertical direction, and each of four “high Ra” LED chips in the vertical direction are alternately arranged along the longitudinal direction. Due to this arrangement, the group of LED chips of “low Ra” and “high Ra”, that is, a group of the general color rendering indexes Ra which is approximately the same is able to perform approximately uniform lighting using a target general color rendering index Ra which is created by each light source without being biased. In addition, the “low Ra” in FIG. 4 denotes an LED chip of which the general color rendering index Ra is low, and the “high Ra” denotes an LED chip of which the general color rendering index Ra is high. “L” denotes an LED chip whose correlated color temperature is low, and “W” denotes an LED chip whose correlated color temperature is high.

Subsequently, the control unit 30 is a unit which controls the light flux, the correlated color temperature, and the general color rendering index Ra of each of the light sources 11 to 14 which is configured as above. As shown in the electrical circuit diagram in FIG. 5, the first to fourth light sources 11 to 14 in which twelve LEDs are connected in series are provided with a lighting circuit 31, respectively, and the control unit 30 is provided between each of the light circuits 31 and a power source E. The control unit 30 is configured by a microcomputer or the like, respectively controls each elements of the correlated color temperature, and the general color rendering index Ra by controlling the light flux, and creates various lighting environments by further controlling an optical output.

For example, in order to make the color appearance at a correlated color temperature 3500 K (close to incandescent-lamp color) good, and to obtain a lighting environment of a high general color rendering index Ra 95, the following control is performed.

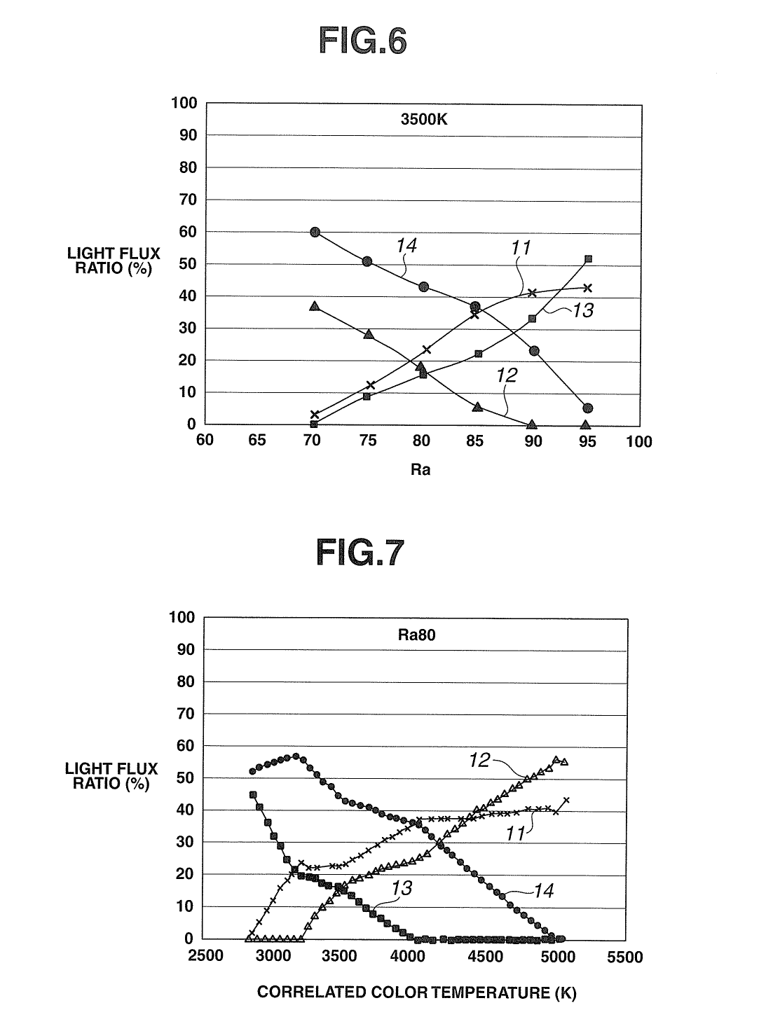

When the light flux of the equipment is set to 4000 μm constantly, the graph shown in FIG. 6 shows a dimming rate, that is, a light flux ratio (%) of each of the light sources 11 to 14 when the correlated color temperature is 3500 K, and the general color rendering index Ra is in a range of 70 to 95, shows the relationship between each of the light sources 11 to 14 with a gradation of 5 of the general color rendering index Ra and the light flux ratio (%), and as is clearly shown in the graph, it is possible to create a lighting environment of the general color rendering index Ra 95 at the correlated color temperature 3500 K by performing the dimming control, respectively, for example,

by setting the light flux ratio of the first light source 11 (curve 11) which is configured by the first LED whose correlated color temperature is 5000K, and whose general color rendering index Ra is 92 to approximately 43%,

setting the light flux ratio of the second light source 12 (curve 12) configured by the second LED whose correlated color temperature is 5000 K, and whose general color rendering index is 70 to approximately 0%,

setting the light flux ratio of the third light source 13 (curve 13) configured by the third LED whose correlated color temperature is 2700 K, and whose general color rendering index is 92 to approximately 52%,

and setting the light flux ratio of the fourth light source 14 (curve 14) configured by the fourth LED whose correlated color temperature is 2700K, and whose general color rendering index is 67 to approximately 5%.

Similarly, it is possible to create a lighting environment of the general color rendering index Ra 85 by performing a respective dimming control, for example, by setting the light flux ratio of the first light source 11 to approximately 36%, setting the light flux ratio of the second light source 12 to approximately 5%, setting the light flux ratio of the third light source 13 to approximately 22%, and setting the light flux ratio of the fourth light source 14 to approximately 36%. Similarly, it is possible to create a lighting environment of the general color rendering index Ra in a range of approximately 70 to 95 when the light flux of the equipment is set to be constant, and the correlated color temperature is 3500 K (close to incandescent-lamp color), by performing the dimming control with respect to each light flux ratio of each of the light sources 11 to 14.

In addition, as shown in a graph in FIG. 6, similarly to the above description, it is possible to create various lighting environments with a variety of general color rendering indexes Ra in a variety of correlated color temperatures by making the light flux of the equipment constant, and by extracting a relationship between a light flux ratio (%) of each of the light sources 11 to 14 in the correlated color temperature, for example in a range of 2850 K to 5000 K, that is, the dimming rate and the general color rendering index Ra. In addition, it is also possible to create the lighting environment continuously, and arbitrarily, along the curve of each graph.

In addition, in order to obtain a lighting environment, for example, whose general color rendering index Ra is 80, and whose correlated color temperature is 5000 K (close to neutral white color), the following control is performed.

When the light flux of the equipment is set to 4000 μm constantly, the graph shown in FIG. 7 shows the dimming rate, that is, the light flux ratio (%) of each of the light sources 11 to 14 when the general color rendering index Ra is 80, and the correlated color temperature is in a range of 2850 to 5000 K, and shows the relationship between each of the light sources 11 to 14 with a gradation of 50 K of the correlated color temperature and the light flux ratio (%), and as is clearly shown in the graph, it is possible to create a lighting environment of the correlated color temperature 5000 K in the general color rendering index Ra 80 by performing the dimming control, respectively, for example,

by setting the light flux ratio of the first light source 11 (curve 11) which is configured by the first LED whose correlated color temperature is 5000K, and whose general color rendering index Ra is 92 to approximately 40%,

setting the light flux ratio of the second light source 12 (curve 12) which is configured by the second LED whose correlated color temperature is 5000K, and whose general color rendering index Ra is 70 to approximately 55%,

setting the light flux ratio of the third light source 13 (curve 13) which is configured by the third LED whose correlated color temperature is 2700K, and whose general color rendering index Ra is 92 to approximately 0%,

and setting the light flux ratio of the fourth light source 14 (curve 14) which is configured by the fourth LED whose correlated color temperature is 2700 K, and whose general color rendering index Ra is 67 to approximately 0%.

Similarly, it is possible to create a lighting environment of the correlated color temperature of 4000 k by performing a respective dimming control, for example, by setting the light flux ratio of the first light source 11 to approximately 38%, setting the light flux ratio of the second light source 12 to approximately 25%, setting the light flux ratio of the third light source 13 to approximately 0%, and setting the light flux ratio of the fourth light source 14 to approximately 38%. Similarly, it is possible to create various lighting environments of the correlated color temperature in a range of 2850 K to 5000 K when the light flux of the equipment is set to be constant, and the general color rendering index Ra is 80, by controlling the light flux ratio of each light source.

In addition, as shown in the graph in FIG. 7, similarly to the above description, it is possible to create various lighting environments with a variety of correlated color temperatures in a variety of general color rendering indexes Ra by making the light flux of the equipment constant, and by extracting a relationship between the light flux ratio (%) of each of the light sources 11 to 14 in the general color rendering index Ra, for example, in a range of 70 to 95, that is, the dimming rate and the correlated color temperature (K). In addition, it is also possible to create the lighting environment continuously, and arbitrarily, along the curve of each graph.

In addition, as described above, in the control unit 30, it is possible to respectively control each element of the correlated color temperature (K), and the general color rendering index Ra by controlling the light flux of each of the light sources 11 to 14, and to create various lighting environments arbitrarily, by further controlling the optical output. In addition, it is possible to create the various lighting environments by controlling at least two elements among the elements, for example, the light flux and the correlated color temperature, the light flux and the general color rendering index Ra, or the correlated color temperature and the general color rendering index Ra, or the like, without controlling all the elements.

In addition, the control unit 30 may perform a control so as to create various lighting environments arbitrarily, or continuously, by performing a frequency calculation by a calculation unit; however, the control unit may create various lighting environments and scenes, by storing a table in which a predetermined variety of lighting patterns, that is, the dimming rate of each of the light sources 11 to 14 in a range of the light flux, the general color rendering index Ra, and the correlated color temperature which are executable, are calculated in advance in a storage unit, and by calling the stored lighting patterns appropriately. The lighting patterns to be stored are, for example, time elements such as time periods of a day of morning, afternoon, and night, or seasons, elements of nature such as weather, or a temperature, the status of use of a room, usage environment of a house, an office, a work place, a factory, or the like, and a variety of lighting patterns may be created in consideration of each of these elements.

Subsequently, the operation unit 35 is able to realize light of spectral distribution with a designated general color rendering index Ra and a designated correlated color temperature by respectively designating an arbitrary general color rendering index Ra within a predetermined range and a correlated color temperature within a predetermined range on the interface of the lighting device 10.

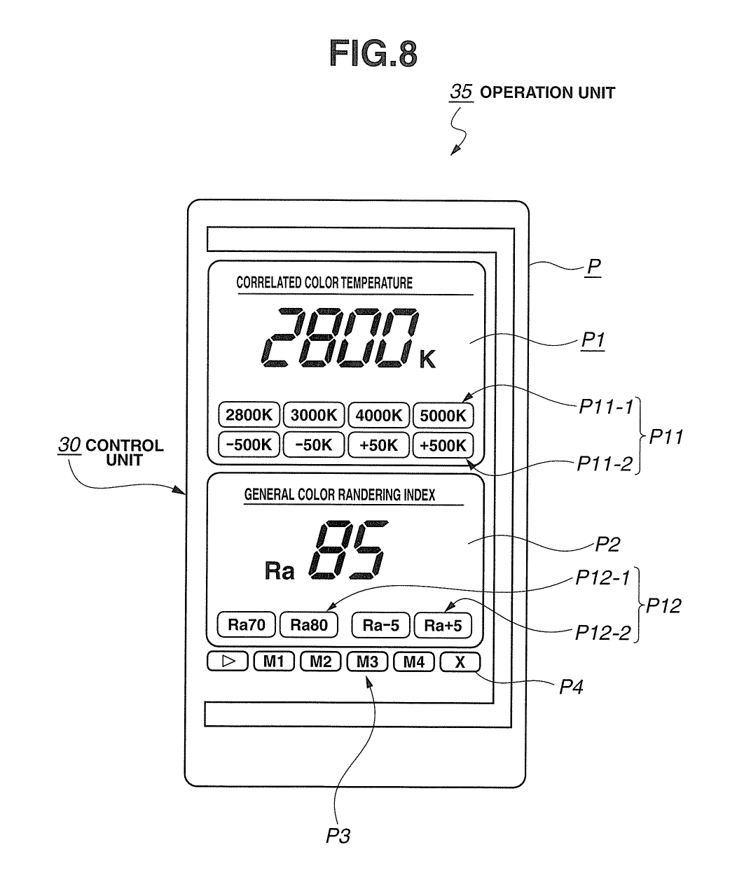

In addition, as shown in FIG. 8, the operation unit according to the embodiment is configured by an operation panel P which is provided on a wall or the like of a room. The operation panel P is built with the control unit 30 which is formed of the above-described microcomputer or the like in a panel case, and is configured by a first display unit P1 and a second display unit P2 which are formed of color liquid crystal panels, a first operation button P11, a second operation button P12, a memory button P3, and a reset button P4 which are touch types, on the front surface thereof. In addition, the operation unit 35 may be configured by a remote controller R. In addition, the control unit 30 may be arranged at the lighting equipment or the like to be described later, without being built in the operation panel P, or the remote controller R.

The first display unit P1 displays the correlated color temperature, and the second display unit P2 displays the general color rendering index Ra, the first display unit P1 is provided at the upper part, and the second display unit P2 is provided at the lower part.

The first operation button P11 is provided at the lower part of the first display unit P1 which displays the correlated color temperature, and is provided with a numerical value button P11-1, and a numerical value adjusting button P11-2 for further finely designating the designated correlated color temperature.

According to the embodiment, the numerical value button P11-1 displays numerical values of 2800 K, 3000 K, 4000 K, and 5000 K, and it is possible to designate a target correlated color temperature by pressing a button of the displayed correlated color temperature.

In addition, according to the embodiment, the numerical value adjusting button P11-2 is configured by numerical value adjusting buttons of “−500 K” and “−50 K” for adjusting the designated value of the numerical value button P11-1, for example, adjusting the value by subtracting 500 K, or 50 K from 3000 K, and numerical value adjusting buttons of “+50 K” and “+500 K”, for example, for adjusting the value by adding 500 K, or 50 K to 3000 K.

The second operation button P12 is provided at the lower part of the second display unit P2 which displays the general color rendering index Ra, and is provided with a numerical value button P12-1 for designating the general color rendering index Ra, and a numerical value adjusting button P12-2 for further finely designating the designated general color rendering index Ra.

According to the embodiment, the numerical value button P12-1 displays numerical values of Ra 70 and Ra 80, and it is possible to designate a target general color rendering index Ra by pressing a button of the displayed general color rendering index Ra.

In addition, according to the embodiment, the numerical value adjusting button P12-2 is configured by a numerical value adjusting button of “Ra-5” for adjusting a designated value of the numerical value button P12-1, for example, adjusting the value by subtracting Ra 5 from Ra 80, and similarly, a numerical value adjusting button of “Ra+5” for adjusting the value, for example, by adding Ra 5 to Ra 80.

In addition, the operation unit 35 shown in FIG. 8 shows a state where the correlated color temperature is designated to 2800 K, and the general color rendering index R is designated to 85, and the values are displayed on the display units P1 and P2, respectively.

In addition, for example, the following operation is performed in order to make the color appearance good when the correlated color temperature is 3500 K (close to incandescent-lamp color), and to obtain a lighting environment of a high general color rendering index Ra 95.

First, the correlated color temperature of 3500 K is designated by pressing the first operation button P11. Subsequently, the general color rendering index Ra 95 is designated by pressing the second operation button P12. In this manner, the designated signal is transmitted to the control unit 30, and a dimming rate (light flux ratio %) of each of the light sources 11 to 14 is calculated by the calculation unit of the control unit 30, and each of the light sources 11 to 14 is subject to lighting control by the calculated dimming rate. In this manner, it is possible to create the lighting environment with the high general color rendering index Ra 95, that is, a lighting environment with a good color appearance, when the correlated color temperature is 3500 K (close to incandescent-lamp color).

Similarly, by selecting and designating the first and second operation buttons 11 and 12, it is possible to create various lighting environments in which the general color rendering index Ra is in a range of 65 to 85 when the correlated color temperature is in a range of 2300 K to 5500 K.

In addition, for example, in order to obtain a lighting environment in which the general color rendering index Ra is 80, and the correlated color temperature is 5000 K (close to neutral white), a setting of the previously set lighting environment is reset by pressing the reset button P4, and the general color rendering index Ra 80 is designated firstly, by pressing the second operation button 12. Subsequently, the correlated color temperature of 5000 K is designated by pressing the first operation button P11. In this manner, the designated signal is transmitted to the control unit 30, and a dimming rate (light flux ratio %) of each of the light sources 11 to 14 is calculated by the calculation unit of the control unit 30, and each of the light sources 11 to 14 is subject to lighting control by the calculated dimming rate. In this manner, it is possible to create the lighting environment with the general color rendering index Ra 80, and the correlated color temperature of 5000 K (close to neutral white).

Similarly, by selecting and designating the second and first operation buttons 12 and 11, it is possible to create various lighting environments in which the correlated color temperature is in a range of 2300 K to 5500 K when the general color rendering index Ra is 80. Similarly, by selecting and designating the second and first operation buttons 12 and 11, it is possible to create various lighting environments in which the correlated color temperature is in a range of 2300 K to 5500 K when the general color rendering index Ra is in a range of 65 to 85.

In addition, the memory button P3 is a button for calling a lighting pattern which is stored in the control unit 30, and according to the embodiment, there are four memory buttons (M1, M2, M3, and M4). In addition, by selecting and pressing the four memory buttons P3, respectively, it is possible to create various lighting environments and scenes, by calling a table which holds the dimming rates of each of the light sources 11 to 14 calculated in advance for a variety of predetermined lighting patterns, that is, in a range of an executable light flux, general color rendering index Ra, and correlated color temperature, and is stored in the storage unit.

According to the embodiment, the memory button (M1) is set with a lighting environment in which the general color rendering index Ra is high, and which is close to sunlight, the memory button (M2) is set with a lighting environment in which the correlated color temperature is in the vicinity of 3000 K, and which has mainly incandescent-lamp color with warmth in a living room in winter, the memory button (M3) is set with a lighting environment in which the correlated color temperature is in the vicinity of 5000 K, and which has mainly neutral soft white color in a living room in spring, or autumn, and the memory button (M4) is set with a lighting environment in which the correlated color temperature is in the vicinity of 6500 K, and which has mainly bluish and cool daylight color in a living room in summer. Each lighting environment is configured so as to be created by being simply and reliably designated, by simply pressing the memory button P3.

In addition, according to the embodiment, each of the light sources 11 to 14 is configured so as to be designated with both the correlated color temperature and the general color rendering index Ra; however, it may be configured by designating any one of the correlated color temperature and the general color rendering index Ra, that is, by designating at least one of the correlated color temperature and the general color rendering index Ra to create various lighting environments. In addition, the light sources may be configured so as to create an energy saving mode in which the optical output is reduced.

In addition, the light sources may be configured so as to be designated to an arbitrary numerical value using numeric keys in a range of the light flux, the general color rendering index Ra, and the correlated color temperature which are executable, or may be configured such that the light flux, the general color rendering index Ra, and the correlated color temperature can be continuously changed with respect to a lighting environment which is different from the designated lighting environment.

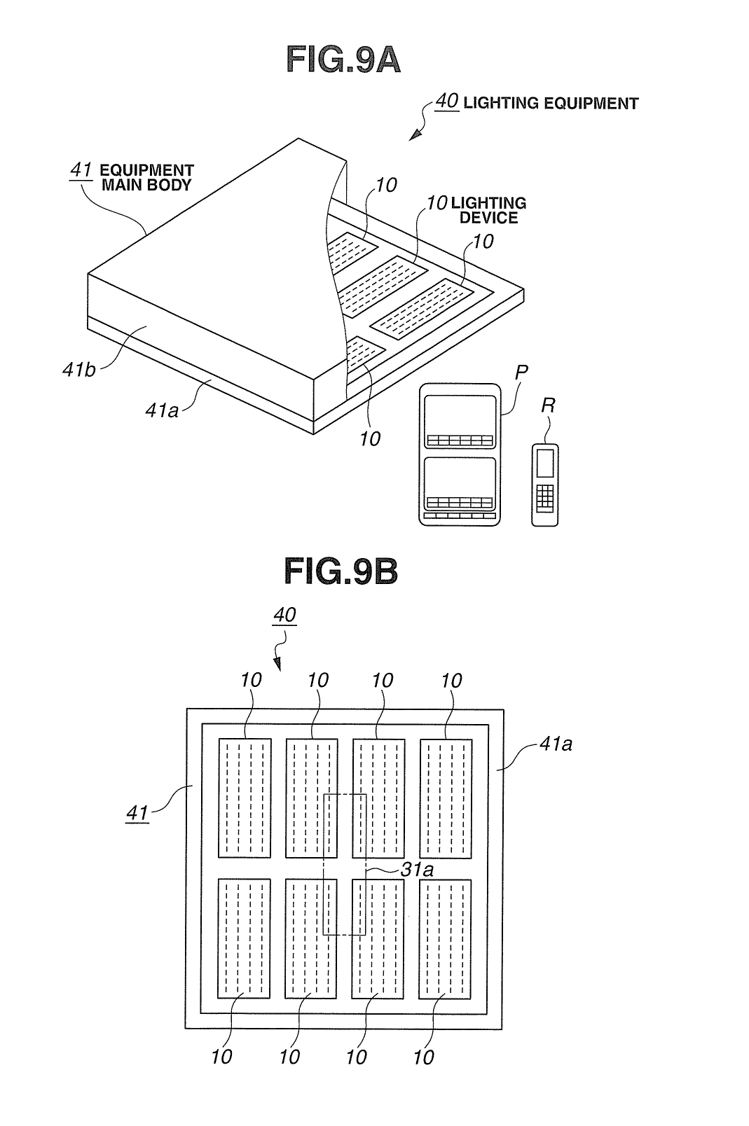

As described above, the lighting device 10 is configured, which includes the light sources 11 to 14 which are formed of each of the first to fourth LEDs mounted on the substrate 16, the control unit 30 which controls each light source, and the operation unit 35. The lighting device 10 which is configured as described above may be configured by one lighting device 10; however, the lighting equipment is configured by the plurality of lighting devices. As shown in FIGS. 9A and 9B, the lighting equipment according to the embodiment is configured as a ceiling implantation type in which eight lighting devices 10 are used.

Subsequently, a configuration of the lighting equipment will be described. As shown in FIGS. 9A and 9B, a lighting equipment 40 is configured by an equipment main body 41, and the lighting device 10 with the above configuration which is arranged in the equipment main body 41.

The equipment main body 41 is configured by a base body 41a which is formed of an approximately square shaped steel plate or the like, and a shade 41b which is formed of milky-white synthetic resin which covers the base body 41a. The horizontal and vertical dimensions of the equipment main body 41 according to the embodiment are approximately 600 mm each.

The lighting devices 10, for example, eight in number, which are configured as above are provided in the base body 41a. The eight lighting devices 10 are divided into two fours, and are arranged approximately in parallel to one side of the square base body 41a respectively, and with equivalent intervals from each other. Each of the lighting devices 10 is electrically connected to be in parallel, each lighting circuit 31 of each of the light sources 11 to 14 in the eight lighting devices 10 is collected, is accommodated in a lighting case 31a with the control circuit 30, and is arranged at the rear surface side of the base body 41a. In addition, each lighting device 10 is connected to the power source E through each lighting circuit 31 and the control unit 30.

In addition, according to the embodiment, the lighting equipment 40 is configured as an equipment of which color is variable, or as a variable color rendering equipment by the eight lighting devices 10 in which four types of LEDs of the incandescent-lamp color whose correlated color temperature is in the vicinity of approximately 3000 K, and whose general color rendering indexes Ra are 60 and 90, or LEDs of the daylight color whose correlated color temperature is in the vicinity of approximately 6500 K, and whose general color rendering indexes Ra are 60 and 90.

In addition, according to the embodiment, the control unit 30 is configured so as to create various lighting environments by commonly controlling dimming rate data items of the eight lighting devices 10 as the same data as each other; however, the dimming rate data of the eight lighting devices 10 may be controlled individually as data different from each other. For example, the control unit may combine the incandescent-lamp color, the neutral color, the daylight color or the like, or may create the energy saving mode in which four optical outputs are reduced, and are not lighted. In addition, in the figure, P is the operation panel which is provided on a wall face of a room, R is the remote controller which transmits a radio signal for creating target lighting environment to the control unit 30, accordingly, it is possible to provide both the operation panel P and the remote controller R, or to provide any one of them. In addition, the control unit 30 may be provided at the operation panel P, or in the remote controller R.

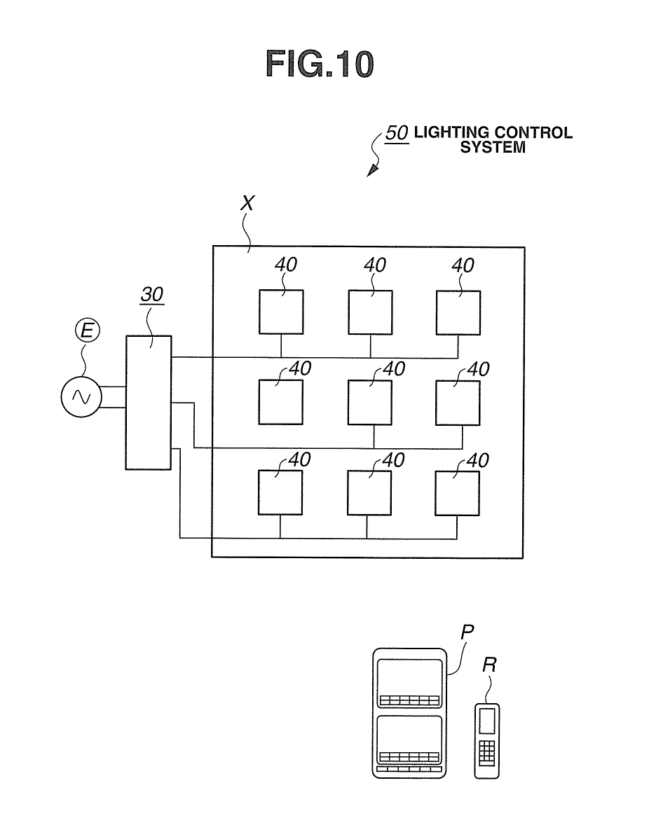

Subsequently, a configuration of a lighting control system which is provided in a lighting showroom at which the lighting equipment with the above configuration is used will be described. As shown in FIG. 10, a lighting control system 50 according to the embodiment is configured by using nine lighting equipments 40 with the above-described configuration.

Each the lighting equipment 40 is provided so as to be located at an approximately square ceiling X in the showroom (room) with equal intervals to each other in three columns by three. In addition, each the lighting equipment 40 is electrically connected so as to be in parallel, and is configured so that the control unit 30 for commonly controlling the nine lighting equipments 40 is provided at the ceiling or the like. In addition, the lighting system 50 is configured by the operation panel P which is provided on the wall face, and the provided remote controller R.

The lighting system 50 which is configured as described above is able to let a visitor of the showroom experience a continuous change in the color temperature and a color rendering property by operating the remote controller R, or the operation panel P by a guide. In particular, according to the embodiment, it is possible to change the general color rendering index Ra, that is, the color rendering property, a change in complexion of a resident which become good, or bad is prominent, accordingly, it is possible to experience the change in the general color rendering index Ra in practice. In addition, it is possible to change the correlated color temperature at the same time, and to experience a change in the correlated color temperature, for example, an atmosphere of a space in which lighting is changed from the incandescent-lamp color to the neutral color, and further to the daylight color. In addition, each lighting environment which is stored in advance can be simply and reliably created, by simply pressing the button of the remote controller R. Further, it is also possible to reproduce a variety of lighting design specifications, to make the showroom as a place of determining the specification, and in particular, to provide a preferable lighting control system for the lighting showroom.

Note that, in the lighting control system according to the embodiment, the control unit 30 is configured so as to be able to create various lighting environments by commonly controlling the dimming rate data items of the nine lighting equipments 40 as the same data as each other; however, the dimming rate data of the nine lighting equipments 40 may be controlled individually as data different from each other. For example, the equipment of the incandescent-lamp color, neutral color, daylight color or the like, may be combined, or it is possible to create an energy saving mode in which a part of the optical outputs of the equipment is reduced, and is not lighted. In addition, according to the embodiment, the lighting control system 50 is configured only by the lighting equipment 40; however, the lighting control system may be configured by combining the lighting equipment 40 and the lighting device 10. Further, the lighting control system may be configured only by the lighting device 10.

As described above, in the embodiment, each light source is configured by the LED; however, the light source may be configured by combining an incandescent light bulb, a fluorescent lamp, or the like, instead of the LED, or may be configured by combining the incandescent light bulb, the fluorescent lamp, or the like, to the LED. In addition, the light source is configured by light sources whose correlated color temperatures are 5000 K, or more, and 3000 K, or less; however, it may be configured by a light source whose correlated color temperature is in a range of 5000 K to 3000 K, depending on usage. In addition, the light source is configured by light sources whose general color rendering indexes Ra are 90 or more, and 70 or less; however, it may be configured by a light source whose general color rendering index is in a range of 90 to 70, depending on the usage.

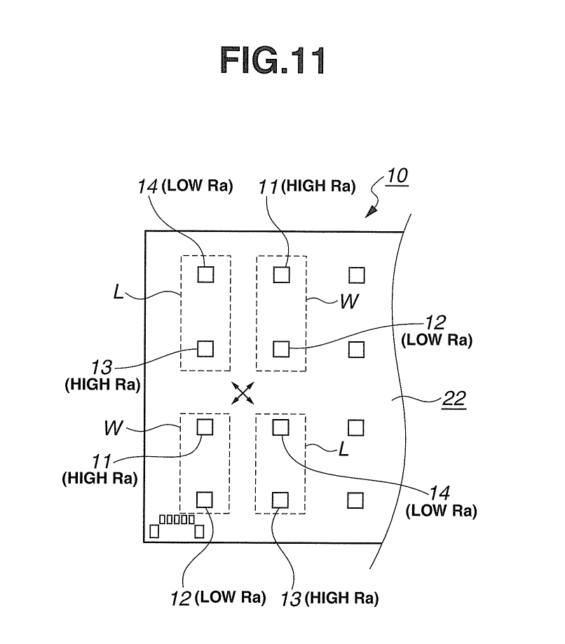

In addition, the arrangement of each light source to the substrate is, as shown in FIG. 11 by enlarging a part thereof, when viewing the rectangular light emitting module 22 in a unit of eight in the vertical direction of the drawing, as shown in groups of a dotted-lined frame in the drawing, LED chips “L” with the low correlated color temperature, and LED chips ‘W” with the high correlated color temperature are alternately arranged. In other words, groups of the LED chips of “L” and “W” are arranged so as to cross each other by being diagonally located as shown by arrows in the drawing. Due to this arrangement, groups of the LED chips of “L” and “W”, that is, groups with approximately the same correlated color temperature as each other is not biased to one side, accordingly, it is possible to perform approximately uniform lighting due to a target correlated color temperature which is created by each light source. In addition, in FIG. 11, the “low Ra” denotes the LED chip in which the general color rendering index Ra is low, and “high Ra” denotes the LED chip in which the general color rendering index Ra is high. “L” denotes the LED chip in which the correlated color temperature is low, and “W” denotes the LED chip in which the correlated color temperature is high.

In addition, according to the above-described embodiment, the operation unit 35 is provided, at least one of the correlated color temperature and the general color rendering index of each light source is designated, thereby realizing spectral distribution with the designated correlated color temperature, or general color rendering index; however, it is also possible to omit the operation unit 35.

Even when the operation unit 35 is omitted, as described above, the control unit 30 is able to perform a control so that various lighting environments are created arbitrarily, or continuously, by performing a calculation each time by the calculation unit, and to create various lighting environments and scenes, by storing a table in which a predetermined variety of lighting patterns, that is, the dimming rate of each of the light sources 11 to 14 in a range of the light flux, the general color rendering index Ra, and the correlated color temperature which are executable, are calculated in advance in the storage unit, and by calling the stored lighting patterns appropriately.

### Second Embodiment

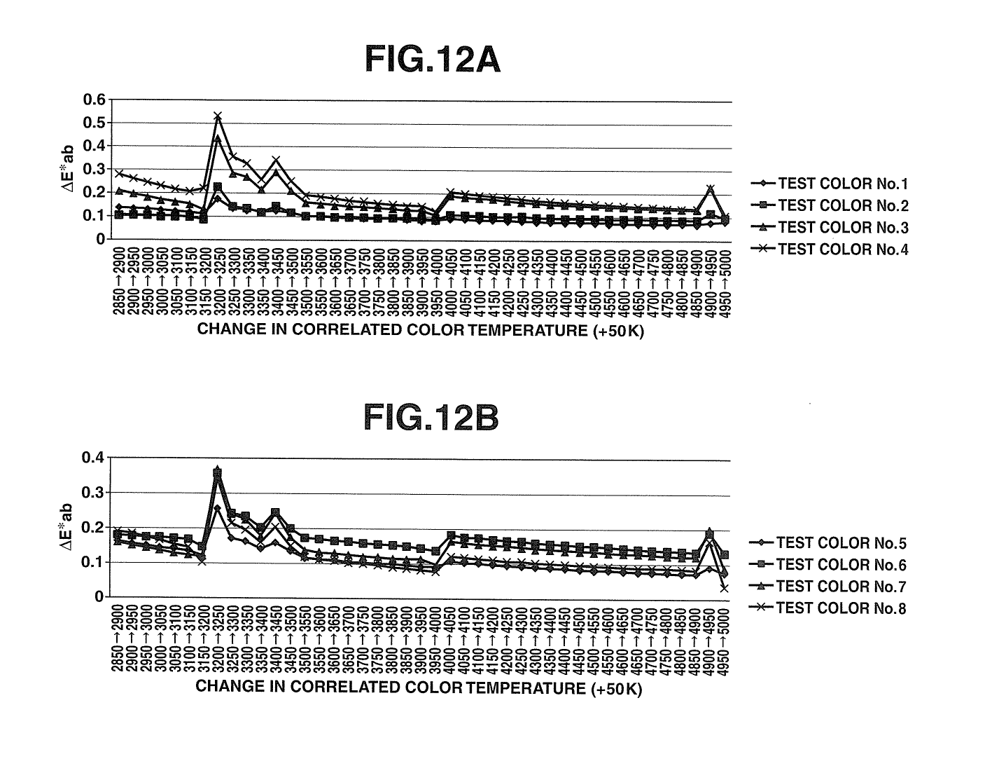

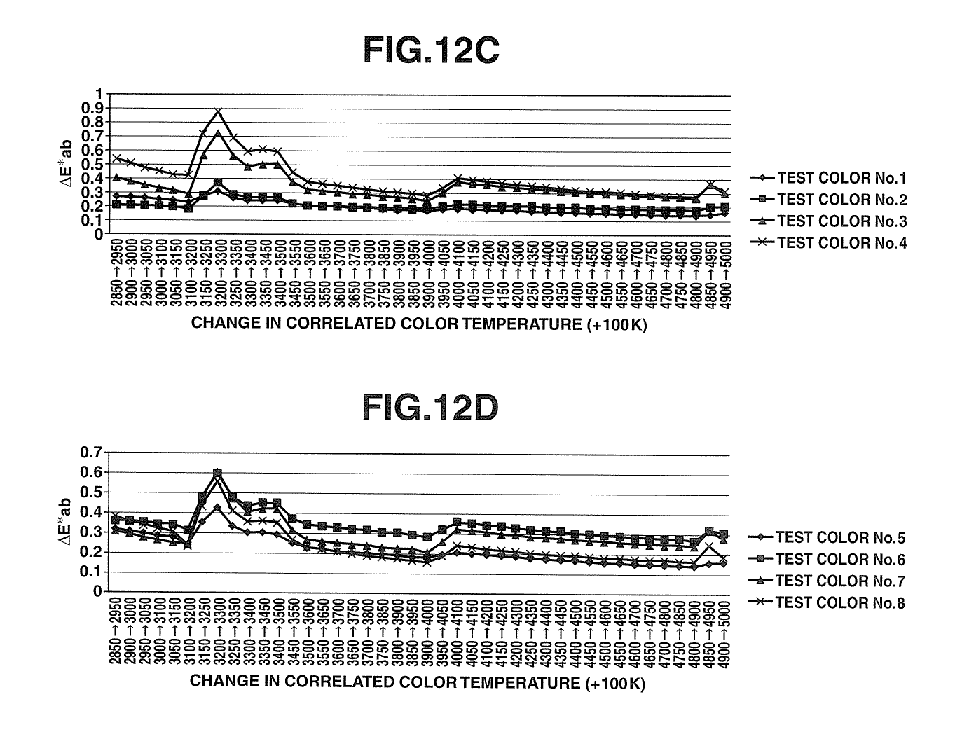

FIGS. 12A to 12D are graphs which describe a second embodiment. A hardware configuration of the embodiment is the same as that of the first embodiment. In the embodiment, a control by a control unit 30 is different from that of the first embodiment. In addition, in the embodiment, an operation unit 35 is omitted, lighting control is performed only by the control unit 30.

FIGS. 12A to 12D are graphs which show a color difference ΔE*ab of JIS color rendering evaluation test color in a lighting device, FIG. 12A is a graph which shows color differences ΔE*ab of JIS color rendering evaluation test colors No. 1 to No. 4 when a light flux of an equipment is set to be constant, a general color rendering index Ra is 80, and a correlated color temperature is changed with a gradation of 50 K, FIG. 12B is a graph which shows color differences ΔE*ab of JIS color rendering evaluation test colors No. 5 to No. 8 when the light flux of the equipment is set to be constant, the general color rendering index Ra is 80, and the correlated color temperature is changed with a gradation of 50 K, FIG. 12C is a graph which shows color differences ΔE*ab of JIS color rendering evaluation test colors No. 1 to No. 4 when the light flux of the equipment is set to be constant, the general color rendering index Ra is 80, and the correlated color temperature is changed with a gradation of 100 K, and FIG. 12D is a graph which shows color differences ΔE*ab of JIS color rendering evaluation test colors No. 5 to No. 8 when the light flux of the equipment is set to be constant, the general color rendering index Ra is 80, and the correlated color temperature is changed with a gradation of 100 K.

According to the embodiment, the control unit 30 controls a color appearance so as not to look unnatural when the correlated color temperature is changed. That is, as described above, when dimming is performed using the four types of light sources (LED), since the dimming rate which realizes a specified correlated color temperature and a specified general color rendering index Ra is multitudinous, for example, when a dimming rate when the correlated color temperature is 4000K, and the general color rendering index Ra is 80 is changed to a dimming rate when the correlated color temperature is 4100 K, and the general color rendering index Ra is 80, there may be a case where the color appearance becomes unnatural.

Therefore, by the control unit 30, it is controlled such that the change in color looks natural by continuously and gradually changing the light flux ratio of the four types of light sources (LED). The ΔE*ab is a color difference (refer to JIS Z 8729 “a method of displaying color-L*a*b* color specification system and L*u*v* color specification system), and for example, when chromaticity of an object in a L*a*b* color space when the correlated color temperature is 4000 K, and the general color rendering index Ra is 80 is set to (L*1, a*1, and b*1), and the chromaticity of the same object as the previous object in a L*a*b* color space when the correlated color temperature is 4100 K, and the general color rendering index Ra is 80 is set to (L*2, a*2, and b*2), it is possible to express as follows.

ΔE*ab=((L*2−L*1)2+(a*2−a*1)2+(b*2−b*1)2)0.5

The lower the ΔE*ab, the smaller the difference in the color of an object under conditions of two light sources. According to the ASTM, “Method E 97 to 53 T” 1953, the limit at the time of strict permission is a ΔE*ab of 0.6 or less, more practically 1.2 or less, and it is possible to show the color as approximately the same color if the color is in this range.

By gradually and continuously changing the light flux ratio as shown in FIG. 7, it is possible to put the ΔE*ab in a range of 0.6 or less, when the correlated color temperature is changed with a gradation of 50 K in a specified general color rendering index Ra, and to put the ΔE*ab in a range of 1.2 or less, when the correlated color temperature is changed with a gradation of 100 K. In this manner, it is possible to show the color of the object without feeling uncomfortable, when the correlated color temperature is changed with gradations of 50 to 100K.

FIGS. 12A and 12B show the ΔE*ab of JIS color rendering evaluation test colors No. 1 to No. 4 and No. 5 to No. 8 when the general color rendering index Ra is 80, and the correlated color temperature is changed with a gradation of 50 K. In addition, 12C and 12D show the ΔE*ab of JIS color rendering evaluation test colors No. 1 to No. 4 and No. 5 to No. 8 when the general color rendering index Ra is 80, and the correlated color temperature is changed with a gradation of 100 K. In addition, in the graphs in FIGS. 12A to 12D, indication of the test colors No. 1 to No. 8 denotes the JIS color rendering evaluation test colors No. 1 to No. 8.

As clearly shown from above, it is possible to create a continuous lighting pattern with no uncomfortable feeling without an unnatural change in color appearance by performing a control by the control unit 30 so that the change in color in JIS color rendering evaluation test colors No. 1 to No. 8 becomes a color difference ΔE*ab of 0.9 or less, when the correlated color temperature is 2850 K or more at the time of changing the correlated color temperature with gradations of 50 K to 100 K under the constant condition of the general color rendering index Ra.

In addition, even in the embodiment, the control unit 30 is configured so as to create various lighting environments in which the color appearance is natural by commonly controlling the dimming rate data items of the eight lighting devices 10 as the same data as each other; however, the dimming rate data items of the eight lighting devices 10 may be individually controlled as data items which are different from each other. For example, the control unit may combine the incandescent-lamp color, neutral color, daylight color or the like, or may create the energy saving mode in which four optical outputs are reduced, and are not lighted.

In addition, when the embodiment is applied to the above lighting control system 50, it is possible to make a visitor of the showroom experience a continuous change in the color temperature and the color rendering property in which the color appearance looks natural by operating the remote controller R, or the operation panel P by a guide.

In addition, even in the lighting control system according to the embodiment, the control unit 30 is configured so as to be able to create various lighting environments in which color appearance is natural by commonly controlling the dimming rate data items of the nine lighting equipments 40 as the same data as each other; however, the dimming rate data of the nine lighting equipments 40 may be controlled individually as data items different from each other. For example, the equipment of the incandescent-lamp color, neutral color, daylight color or the like may be combined, or it is possible to create the energy saving mode in which a part of the optical outputs of the equipment is reduced, and is not lighted. In addition, even in the embodiment, the lighting control system 50 is configured only by the lighting equipment 40; however, the lighting control system may be configured by combining the lighting equipment 40 and the lighting device 10. Further, the lighting control system may be configured only by the lighting device 10.

As described above, according to the embodiment, each light source is configured by the LED; however, the light source may be configured by combining the incandescent light bulbs, the fluorescent lamps, or the like, instead of the LED, or may be configured by combining the incandescent light bulbs, the fluorescent lamps, or the like, to the LED. In addition, the light source is configured by light sources of which the correlated color temperatures are 5000 K, or more, and 3000 K, or less; however, the light source may be configured by a light source of which the correlated color temperature is in a range of 5000 K to 3000 K, depending on usage. In addition, the light source is configured by light sources of which the general color rendering indexes Ra are 90 or more, and 70 or less; however, it may be configured by a light source of which the general color rendering index is in a range of 90 to 70, depending on usage.

In addition, in each above-described embodiment, the lighting equipment may configure, not limited to the above-exemplified illumination showroom, various lighting equipment for facilities such as a shop, and an office, for business, and for residential use, further for outdoor use such as security light, street light, and road light. Hitherto, preferable embodiments of the invention have been described; however, the invention is not limited to the above-described embodiments, and can be performed with a variety of design changes without departing from the scope of the invention.

While certain embodiments have been described, these embodiments have been presented by way of example only, and are not intended to limit the scope of the inventions. Indeed, the novel systems described herein may be embodied in a variety of other forms; furthermore, various omissions, substitutions and changes in the form of the systems described herein may be made without departing from the spirit of the inventions. The accompanying claims and their equivalents are intended to cover such forms or modifications as would fall within the scope and spirit of the inventions.

What is claimed is:

1. A lighting device comprising:
a first light source, a correlated color temperature of which is relatively high, and a general color rendering index of which is relatively high;
a second light source, a correlated color temperature of which is relatively high, and a general color rendering index of which is relatively low;
a third light source, a correlated color temperature of which is relatively low, and a general color rendering index of which is relatively high;
a fourth light source, a correlated color temperature of which is relatively low, and a general color rendering index of which is relatively low;
a control unit which controls at least two of a light flux, the correlated color temperature, and the general color rendering index of each of the light sources; and
an operation unit which designates at least one of the correlated color temperature and the general color rendering index of each of the light sources, and executes spectral distribution with the designated correlated color temperature, or the designated general color rendering index.

2. A lighting device comprising:
a first light emitting diode which includes a blue light emitting diode, and a phosphor which is excited by the blue light emitting diode, a correlated color temperature of which is 5000 K, or more, and a general color rendering index of which is 90, or more;
a second light emitting diode which includes a blue light emitting diode, and a phosphor which is excited by the blue light emitting diode, a correlated color temperature of which is 5000 K, or more, and a general color rendering index of which is 70, or less;
a third light emitting diode which includes a blue light emitting diode, and a phosphor which is excited by the blue light emitting diode, a correlated color temperature of which is 3000 K, or less, and a general color rendering index of which is 90, or more;
a fourth light emitting diode which includes a blue light emitting diode, and a phosphor which is excited by the blue light emitting diode, a correlated color temperature of which is 3000 K, or less, and a general color rendering index of which is 70, or less;
a control unit which controls at least two of a light flux, the correlated color temperature, and the general color rendering index of each of the light emitting diodes; and
an operation unit which designates at least one of the correlated color temperature and the general color rendering index of each of the light emitting diodes, and executes spectral distribution with the designated correlated color temperature, or the designated general color rendering index.

3. A lighting equipment comprising:
an equipment main body; and
the lighting device according to claim 1 which is arranged in the equipment main body.

4. A lighting equipment comprising:
an equipment main body; and
the lighting device according to claim 2 which is arranged in the equipment main body.

5. A lighting control system comprising:
the lighting device according to claim 1.

6. A lighting control system comprising:
the lighting device according to claim 2.

7. A lighting control system comprising:
an equipment main body; and
the lighting device according to claim 1 which is arranged in the equipment main body.

8. A lighting control system comprising:
an equipment main body; and
the lighting device according to claim 2 which is arranged in the equipment main body.

9. A lighting device comprising:
a first light source, a correlated color temperature of which is relatively high, and a general color rendering index of which is relatively high;
a second light source, a correlated color temperature of which is relatively high, and general color rendering index of which is relatively low;
a third light source, a correlated color temperature is relatively low, and a general color rendering index of which is relatively high;
a fourth light source, a correlated color temperature is relatively low, and a general color rendering index of which is relatively low; and
a control unit which controls at least two of a light flux, the correlated color temperature, and the general color rendering index of each of the light sources.

10. A lighting device comprising:
a first light emitting diode which includes a blue light emitting diode, and a phosphor which is excited by the blue light emitting diode, a correlated color temperature of which is 5000 K, or more, and a general color rendering index of which is 90, or more;
a second light emitting diode which includes a blue light emitting diode, and a phosphor which is excited by the blue light emitting diode, the correlated color temperature of which is 5000 K, or more, and a general color rendering index of which is 70, or less;
a third light emitting diode which includes a blue light emitting diode, and a phosphor which is excited by the blue light emitting diode, a correlated color temperature of which is 3000 K, or less, and a general color rendering index of which is 90, or more;
a fourth light emitting diode which includes a blue light emitting diode, and a phosphor which is excited by the blue light emitting diode, a correlated color temperature of which is 3000 K, or less, and a general color rendering index of which is 70, or less; and
a control unit which controls at least two of a light flux, the correlated color temperature, and the general color rendering index of each of the light emitting diodes.

11. A lighting equipment comprising:
an equipment main body; and
the lighting device according to claim 9 which is arranged in the equipment main body.

12. A lighting equipment comprising:
an equipment main body; and
the lighting device according to claim 10 which is arranged in the equipment main body.

13. A lighting control system comprising:
the lighting device according to claim 9.

14. A lighting control system comprising:
the lighting device according to claim 10.

15. A lighting control system comprising:
an equipment main body; and
the lighting device according to claim 9 which is arranged in the equipment main body.

16. A lighting control system comprising:
an equipment main body; and
the lighting device according to claim 10 which is arranged in the equipment main body.

17. The device according to claim 9,
wherein when the control unit changes the correlated color temperature with a gradation of 50 to 100 K based on a certain condition of the general color rendering index, a change in color in JIS color rendering color chart No. 1 to No. 8 becomes a color difference ΔE*ab of 0.9 or less.

18. The device according to claim 10,
wherein when the control unit changes the correlated color temperature with gradations of 50 to 100 K based on a certain condition of the general color rendering index, the change in colors in JIS color rendering color charts No. 1 to No. 8 becomes a color difference ΔE*ab of 0.9 or less.

19. A lighting equipment comprising:
an equipment main body; and
the lighting device according to claim 17 which is arranged in the equipment main body.

20. A lighting control system comprising:
the lighting device according to claim 17.
